(19) United States
(12) Patent Application Publication
(10) Pub. No.: US 2017/0012927 A1
(43) Pub. Date: Jan. 12, 2017

(54) SOCIAL NETWORK COMMUNICATION AND INFORMATION MANAGEMENT SYSTEM

(71) Applicant: Mango Mentors, LLC, Minneapolis, MN (US)

(72) Inventors: Susan Wollan Fan, Minneapolis, MN (US); Jason Voiovich, Shoreview, MN (US)

(21) Appl. No.: 15/206,640

(22) Filed: Jul. 11, 2016

Related U.S. Application Data
(60) Provisional application No. 62/191,070, filed on Jul. 10, 2015.

(51) Int. Cl. H04L 12/58; H04L 29/08

(52) U.S. Cl. CPC H04L 51/32; H04L 67/02; H04L 51/046

(57) ABSTRACT

A digital community platform that enables a first user to connect to a second user. More specifically, a system that helps a first user expand the first user's professional network by using proprietary algorithms and data archetypes to find and recommend new connections from the user's professional network community. Further, the system coaches the user, step-by-step, through networking experiences and includes message builders that are designed to help the user write common networking communications. The system also enables the user to manage follow-up tasks in a professional and timely manner. The system provides analytics and insights that allow a community manager to understand their network community, its user demographics, engagement activities, and user outcomes.

### CROSS-REFERENCE TO RELATED APPLICATION

This application claims the benefit of U.S. Provisional Patent Application No. 62/191,070, filed on Jul. 10, 2015, which is titled SOCIAL NETWORK COMMUNICATION AND INFORMATION MANAGEMENT SYSTEM.

### FIELD OF THE DISCLOSURE

The disclosed invention relates to a digital community platform.

### BACKGROUND OF THE INVENTION

Networking is extremely important today when most jobs never get formally posted. Referred candidates are twice as likely to get interviews and 40 percent more likely to be hired than other candidates. While many may succeed in college or in existing jobs, if they do not make meaningful connections with people in their desired field, their chances of entering and advancing in that field are low.

The opportunity gap and diversity imbalances today can be traced to who is networking and who is not. Today, professional social networks like Linkedln give everyone access to a huge pool of connections, but people are on their own to figure out how to network. Low-income students, first generation college students, people of color, people with disabilities, immigrants and non-native speakers are doubly disadvantaged by traditional networking practices that seem to favor confident, self-promoting, extroverts.

Current technical solutions lack sufficient communication and data analytics to address the foregoing problems.

### SUMMARY OF THE INVENTION

The disclosed system is a technical solution that introduces a more natural style of career connecting that resonates with new networkers, especially millennials. It shows anyone how to reach out to network connections for career advice in a genuine and professional manner. The system is designed to show people how to initiate and structure conversations that provide worthwhile career advice and lead to more job opportunities and referrals. It is also designed to help professional network communities, for example, university alumni groups, professional industry associations, and diversity affinity groups increase engagement and mentoring among their members.

The system is an online tool that shows a user how to reach out to the user's connections for worthwhile career advice. The system coaches a user, step-by-step, through networking experiences, including who to talk to, what to say, what questions to ask and how to follow-up effectively. The system's message builders are designed to help a user to write common networking communications, which meet accepted professional standards and contain text customized for a specific contact. The system also helps a user to manage follow-up tasks in a professional and timely manner. With coaching text embedded throughout the system's user processes, a user builds the skills and confidence needed to initiate networking connections for common career uses, such as job referrals, jobs opportunities, informational interviews, career advice, and exploring career options. The system helps a user to expand their professional network by using proprietary algorithms and data archetypes to find and recommend new connections from a user's professional network community. The system also provides community and social features that help a user and a community manager to invite new users and expand networking activity among users and community members. One example of a network community is a university student-alumni network where a community manager may be a career services student-alumni networking coordinator. The system provides analytics and insights that allow a community manager to understand their network community, its user demographics, engagement activities, and user outcomes.

### BRIEF DESCRIPTION OF THE DRAWINGS

FIG. 1A illustrates a Product Function Overview according to one embodiment of the disclosed system.

FIG. 1B illustrates a Product Function Overview according to one embodiment of the disclosed system.

FIG. 1C illustrates a Product Function Overview according to one embodiment of the disclosed system.

FIG. 2 illustrates a Function Summary according to one embodiment of the disclosed system.

FIG. 3 illustrates an Add Contact process according to one embodiment of the disclosed system.

FIG. 4 illustrates Connection Types according to one embodiment of the disclosed system.

FIG. 5A illustrates a Recommend Connections process according to one embodiment of the disclosed system.

FIG. 5B illustrates a Recommend Connections process according to one embodiment of the disclosed system.

FIG. 6 illustrates a Build Messages process according to one embodiment of the disclosed system.

FIG. 7 illustrates Message Sample according to one embodiment of the disclosed system.

FIG. 8 illustrates Message Builder screen and navigation menu according to one embodiment of the disclosed system.

FIG. 9 illustrates a Conversation Preparation process according to one embodiment of the disclosed system.

FIG. 10 illustrates Questions List Sample according to one embodiment of the disclosed system.

FIG. 11 illustrates Conversation Outline Sample according to one embodiment of the disclosed system.

FIG. 12 illustrates a Manage Connections process according to one embodiment of the disclosed system.

FIG. 13 illustrates a Share process according to one embodiment of the disclosed system.

FIG. 14 illustrates Sign Up and Sign In processes and navigation menu according to one embodiment of the disclosed system.

FIG. 15 illustrates Settings and Feedback processes according to one embodiment of the disclosed system.

FIG. 16 illustrates a Demo process according to one embodiment of the disclosed system.

FIG. 17 is a schematic block diagram depicting an example computing system used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

Product Function Overview

Some of the functions of the system are common to a user interface, such as a sign in/log out 107 function, a profile setup function, a demo 109 function, and a settings and feedback 108 function. Other functions are custom to the disclosed system, such as the Add Contact 101 function, the Recommend Connections 102 feature, the Build Messages 103 function, the Conversation Preparation 104 function, the Manage Connections 105 function, and the Share 106 feature.

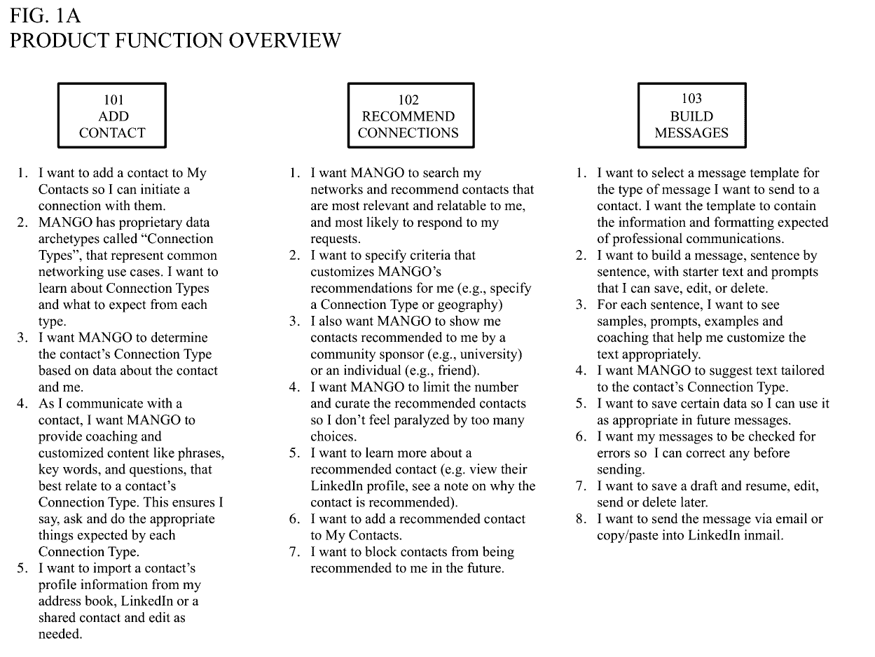

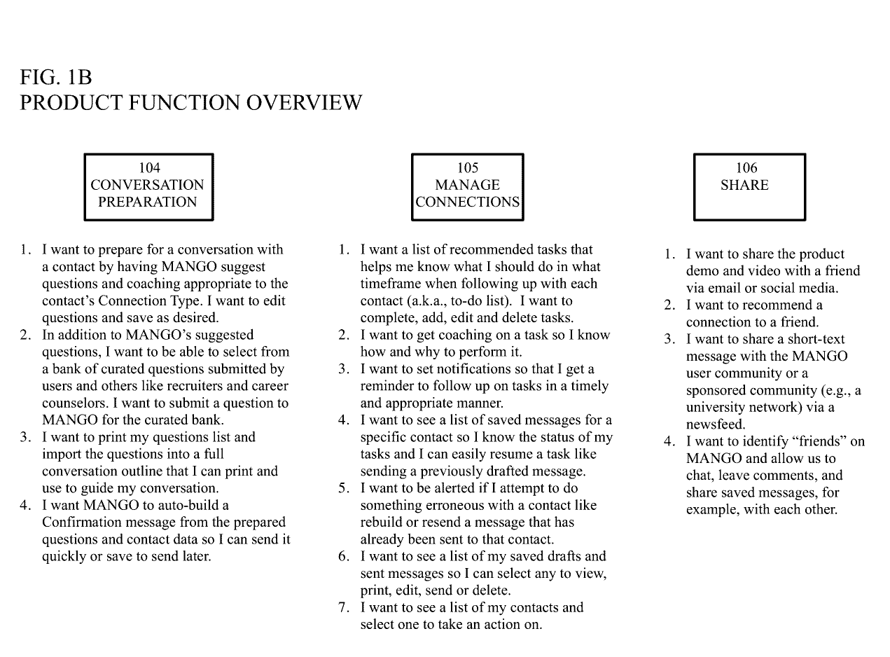

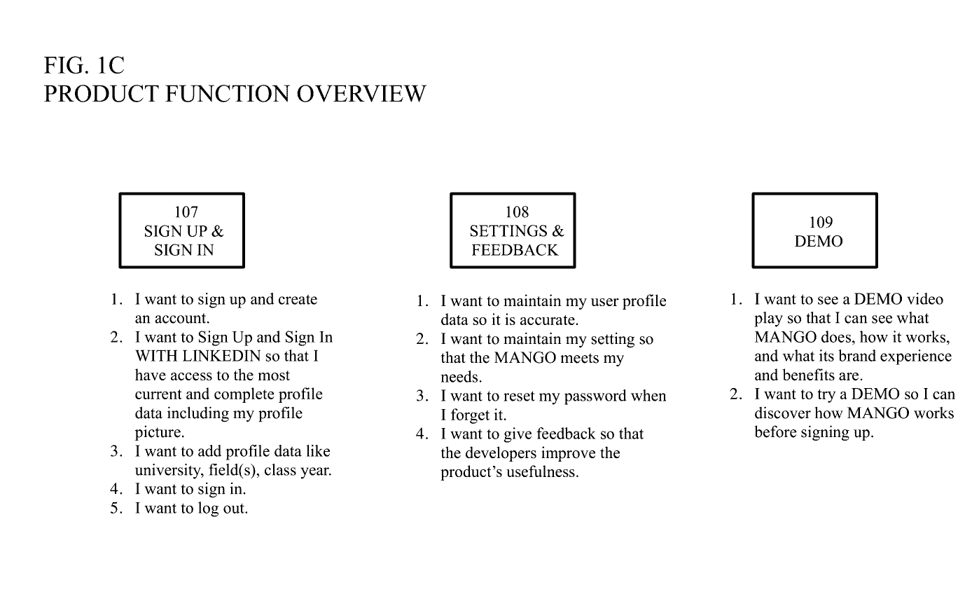

FIGS. 1A-1C illustrates the function detail of the disclosed system wherein, based on the action the user wants to take, the user will use one of the nine main functions of the system (Add Contact 101, Recommend Connections 102, Build Messages 103, Conversation Preparation 104, Manage Connections 105, Share 106, Sign-In and Profile 107, Settings and Feedback 108, and Demo 109). For example, if the user selects a message template for the type of message to send to a contact, the user will be operating within the Build Messages 103 function. Each of the nine functions is described in further detail below.

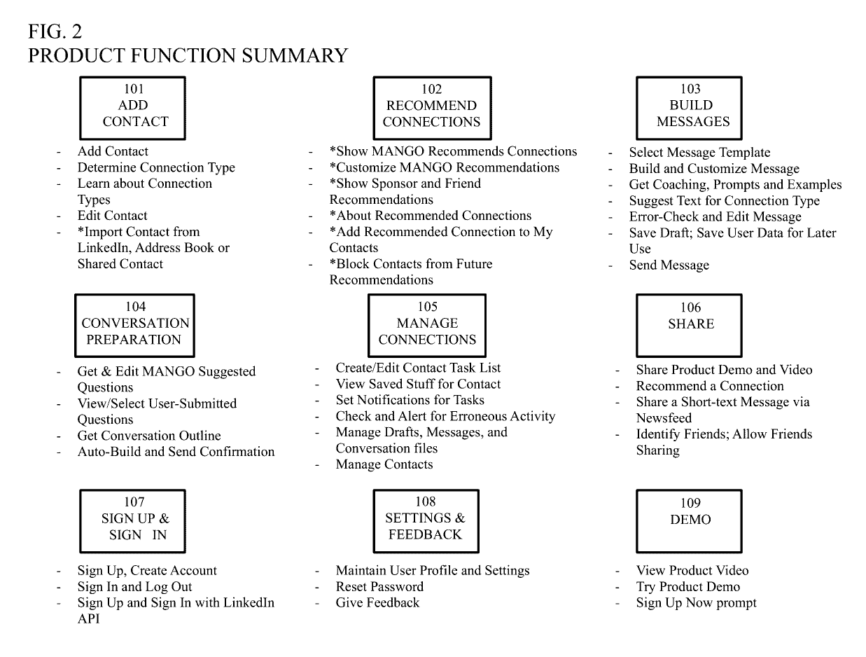

FIG. 2 illustrates a function summary of the disclosed system for each of the nine main functions. The Add Contact 101 function allows the user to add a contact, determine contact's Connection Type, learn about Connection Types, edit contact information, and import a contact from the user's address book, shared contact, or Linkedln connection. The Recommend Connections 102 function allows a user to view connections recommended by the system, a network community, or an individual, as well as customize recommendation settings, review details about a selected recommended connection, add a recommended connection to the user's contacts, and block a contact from future recommendations. The Build Messages 103 function allows a user to select a message template, build and customize a message, get coaching, see prompts and examples, get suggested text tailored to a contact's Connection Type, error check and edit a message, save a draft message, save user data for later use, and send a message. The Conversation Preparation 104 function allows a user to select and edit suggested questions, view and select user-submitted questions, get a conversation outline, and auto-build and send a confirmation message. The Manage Connections 105 function allows a user to create and edit a task list for a contact, view all saved activity for a contact, set notifications for tasks, be alerted regarding erroneous activity like resending a message, manage communication files, and manage contacts. The Share 106 function allows a user to share the product demo and video, recommend a connection to a friend, share a short-text message via a community newsfeed, and identify friends for sharing access. The Sign Up/Sign In 107 function allows a user to sign up by creating an account, set up a profile, sign up/sign in with Linkedln, and log out. The Settings & Feedback 108 function allows a user to update their profile and settings, reset their password, set notification preferences, change privacy settings, and offer feedback regarding the system. The Demo 109 function allows a user to view a product video, try a product demo, and initiate account creation.

In addition to user functions, some embodiments of the system include proprietary data archetypes referred herein as “Connection Types” and contain algorithms used to search a user's network, for example, a user's university alumni network, and recommend connections that are personalized for the user. The system also contains a data-driven rules engine that customizes communications for a contact. For example, as a user is building a message, the system can suggest variations of text customized for a contact. In another example, as a user prepares a question list for an upcoming informational interview, the system can suggest questions that best suit that contact's expected area of knowledge or expertise.

Add Contact

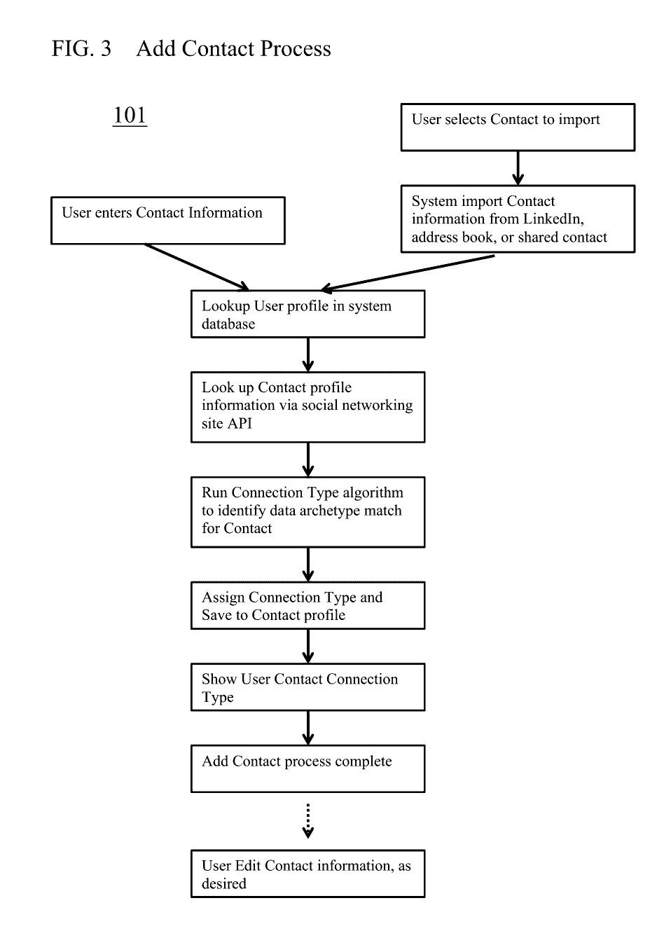

FIG. 3 illustrates how a user can add a contact. A user adds a contact to the disclosed system by entering the contact's name and email address, and optional information (a current job, or field/industry, for example). The disclosed system then assigns the contact a “Connection Type” as described below, and displays the contact and Connection Type description to the user. Upon successfully completing this step, the contact is shown among the user's contact list in the disclosed system. The user is able to select the added contact to perform a number of system activities including build and send messages to the contact, prepare for a conversation, and manage tasks related to the contact.

Connection Types: The disclosed system has defined several proprietary data archetypes (a.k.a. Connection Types) that coincide with connections most likely to assist a user with specific networking needs, such as but not limited to exploring an industry, finding broad industry contacts, finding a referral, learning about the hiring process, and connecting to special resources. In some embodiments, when a user adds a contact the system prompts the user to answer a series of questions related to the contact's career, tenure, and commonality with the user. Based on that information, the system identifies the Connection Type that most likely resembles the contact's relationship to the user. In some embodiments, the system can access the contact's profile and user data, and assign a Connection Type without user intervention. The system can use the contact's Connection Type to suggest content, like text and questions that will most likely resonate with a contact.

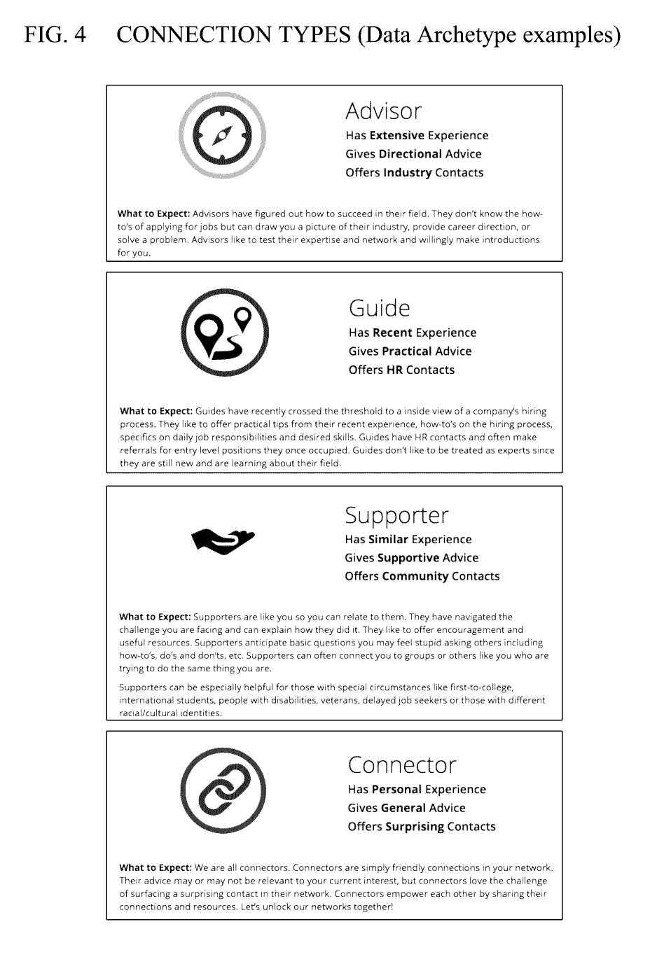

As illustrated in FIG. 4, Connections Types may include but are not limited to Advisors, Guides, Supporters, and Connectors. One example: an Advisor Connection Type has over five years work experience in a user's desired industry and, as such, the system can suggest questions the user can ask the contact that relate to an Advisor's extensive experience. For example, they can ask for an industry overview, industry contacts, and success factors. In another example, a Guide Connection Type has less than five years work experience in a user's desired industry or job, and as such, the system can suggest questions the user can ask the contact that relate to a Guide's recent experience. For example, the user can ask for practical tips for a job search, specific details on the hiring process, an overview of daily job responsibilities, and desired job skills. In another example, a Supporter Connection Type has similar special circumstances in common with the user outside of the user's specific career interest, and as such, the system can suggest questions the user can ask the contact that relate to a Supporter's similar experience. For example, the user can ask about useful resources and community contacts geared toward helping the user overcome or navigate a similar challenge. In another example, the Connector Connection Type is a general data archetype that does not require any specific data matching between a user and a contact, and as such, the system can suggest general questions that can likely be answered by anyone willing to have a friendly networking conversation.

Recommend Connections

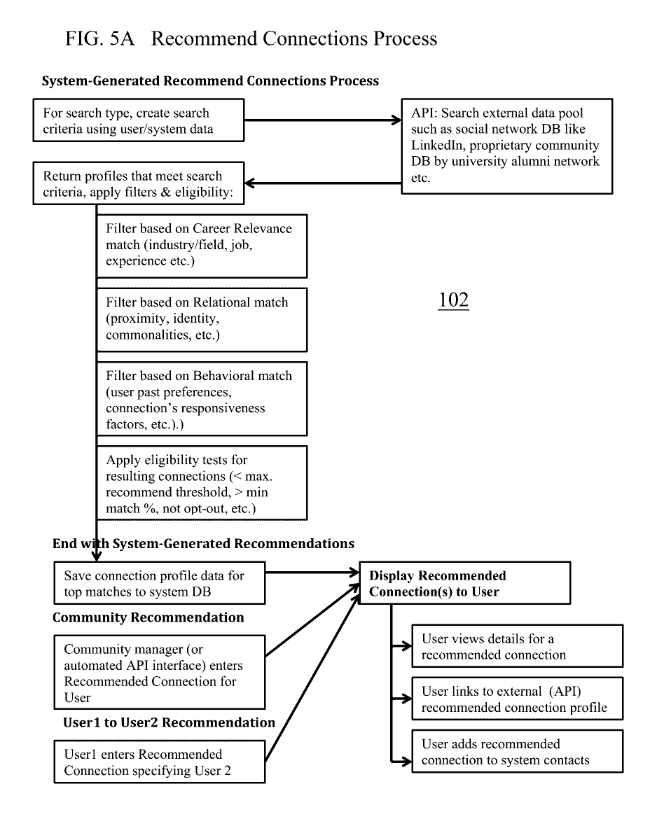

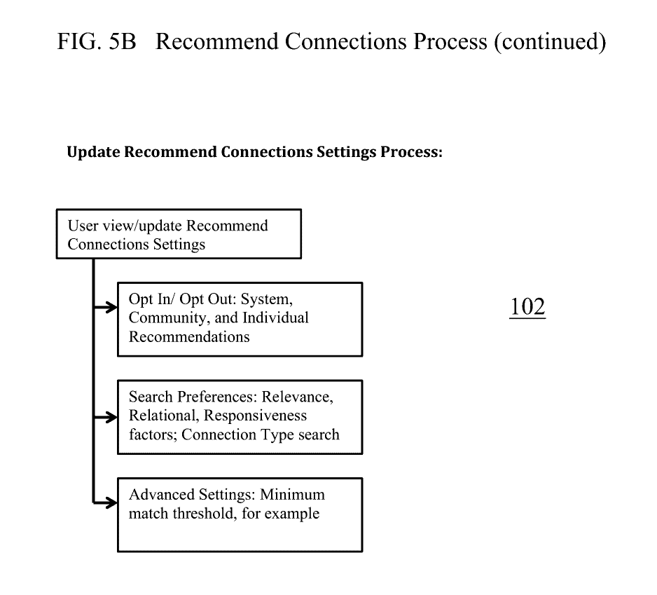

FIGS. 5A and 5B illustrates the recommended connection process. Social networking sites like Linkedln are well-established communities that enable individuals to find each other online based on commonalities such as shared connections, similar education institution, similar majors, or similar careers. In some embodiments, the system uses these established social networking sites and it adds enhanced networking features to enable individuals to find and connect with each other more easily based on their commonalities.

Using established social networking sites, the disclosed system can initiate a connection by recommending relevant connections to a user. In some embodiments, the user can view a connection recommended by a network community (like a university alumni network), or an individual (like a friend).

In some embodiments, a user can control connection recommendations. For example, a user can opt in or opt out of seeing connection recommendations from the system, a network community, and/or an individual. A user can also specify criteria that the system uses to personalize recommendation results, for example, specifying a Connection Type, a geography, a field, an organization, or key words.

The system will track and regulate the frequency at which a connection is recommended so that a connection is not overly taxed. For example, a connection will not get recommended when they have reached the system-defined maximum recommendation threshold, for example, twice per month. In another example, a connection will not get recommended when the match results fails to meet a system-define minimum match threshold, which ensures the connection's profile is sufficiently relevant to the user's need or criteria such as, but not limited to matching the user's desired field, company, role, geography, circumstance, and/or industry. In another example, a connection will not get recommended if the connection fails to respond to user requests over an extended period or explicitly opts out.

To determine which recommendations to make, the disclosed system can search a network pool to find individuals who match a Connection Type or user-specified criteria. The connection pool will ideally be pulled from established social networking sites, such as LinkedIn, to enable users to benefit from their existing connections within well-known, pre-existing social networking systems. After the search is completed, the system can filter and sequence the search results based on relevance factors, relational factors, and behavioral factors weighted to, for example, a Connection Type data archetype, or specified user criteria.

Relevance factors are based on how well a connection matches a user's career interest (such as industry, field of study, location, role, and/or company), expertise (such as tenure in field, seniority), and influence (such as number and strength of connections related to the user's career interest).

Relational factors are based on how the user and connection relate to one another in regard to proximity, identity, and commonality. Proximity can be determined by comparing the users' stage in their career path, class/graduation year, or physical location. Identity can be determined by comparing the user and connection demographics (such as gender, age, race/ethnicity, etc.), country of origin, home state, hometown, educational experiences (such as high school, home school, year abroad, and related activities), and circumstances (e.g., working mom, immigrant, first generation college student, veteran, etc.). Commonality can be determined by comparing the user's university activities (Greek life, collegiate athletics, minority affiliations, ROTC, etc.), personal interests, and volunteer service and causes.

Behavioral factors may include how likely a connection is to respond to a user's networking request. Responsiveness may be determined by comparing elements of the user's network to the connection's network such as closest connection (i.e., first degree of separation) and number of connections in common (indicating how likely it is that the user and connection travel in the same social circles). Another responsiveness factor is a connection's university affiliation and the number of their university-related, first-degree connections. Other responsiveness factors may include whether the user and connection attended a similar university program or type of college, (such as liberal arts, education, engineering, or business school), type of program (such as certificate, major, or minor) and degree level (such as undergraduate, masters, PhD, JD, or MD), the connection's level of network activity (such as frequency of profile updates, connections and messaging), responsiveness with past user requests, and machine learning (i.e., recommend connections based on the user's preferences and past behaviors).

To create more specific and personalized recommendations, the disclosed system can calibrate the weighting of search and sequencing criteria. For example, default settings may return a variety of Connection Types among the connection pool whereas personalized settings may narrow results to a specific Connection Type or profile type. Further, as described above users can opt into or out of recommendations and change settings. These settings can ensure that recommendations are relevant to users and connections and can weed out cold calls or spamming. In some embodiments, the disclosed system will only recommend a connection with a user if the connection is likely to respond.

In some embodiments, the system uses a Recommend Connections algorithm that provides a numerical score that measures three questions: (1) Is the user likely to relate to this person on a personal level? (2) Is this match relevant to the user professionally? (3) Is this person likely to respond to requests from the user?

The algorithm can then match a potential connection (MTR) to a user (MTE) using three data categories: Relevance (R1), Relatability (R2), and Responsiveness (R3). The system can search the connections universe (i.e., an external database such as LinkedIn or a University Alumni database) and return a list of “best percentage matches” starting with, for example, the highest percentage listed first.

An initial algorithm formula can be: Average, weighted score on all factors from 1-100=((R1−n)*(R1 individual weightings FMW-0)*(R1 individual scores)/(n of R1))+((R2−n)*(R2 individual weightings FMW-0)*(R2 individual scores)/(n of R2))+((R3−n)*(R3 individual weightings FMW-0)*(R3 individual scores)/(n of R3)).

The Factor Match Weight (FMW-0) represents the initial weighting criteria. As the system gathers and analyzes actual interactions, the weighting can shift to more heavily weight those factors that explain positive variability. One way it can do this is through multiple regression analysis.

The algorithm can additionally develop behavioral profiles of MTR and MTEs and adjust the algorithm appropriately. For example, the match score generated will eventually vary at the overall level as well as by behavioral category matches between MTR and MTEs that impact R3 factors.

Build Messages

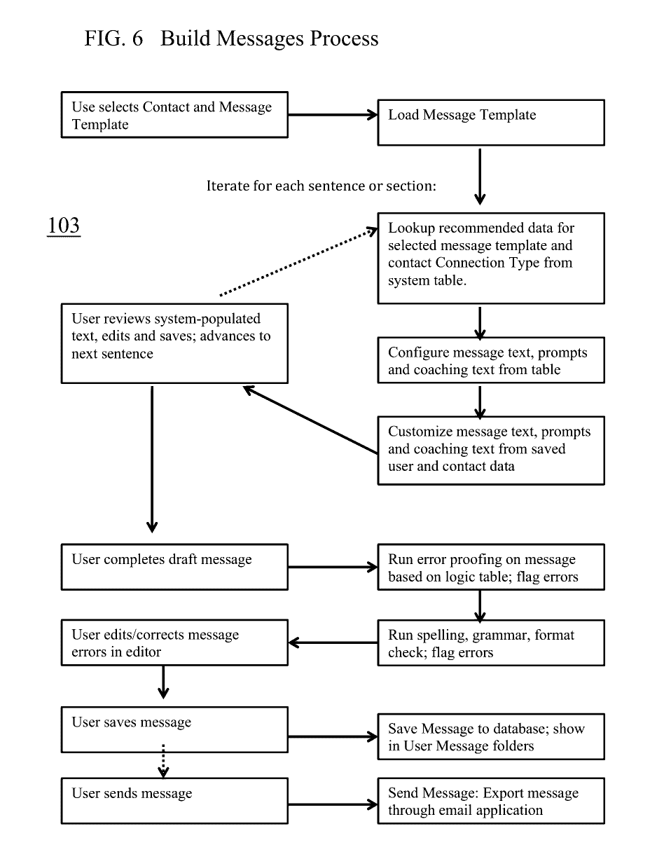

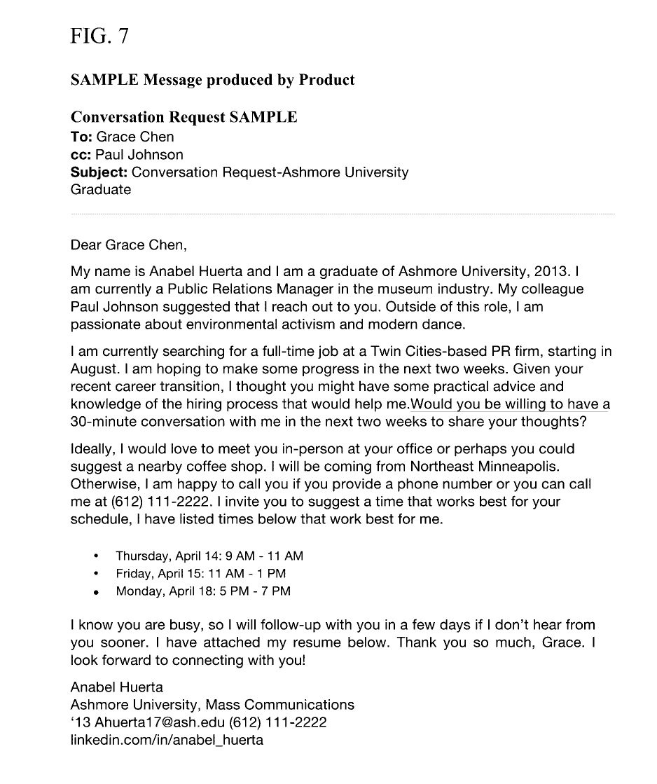

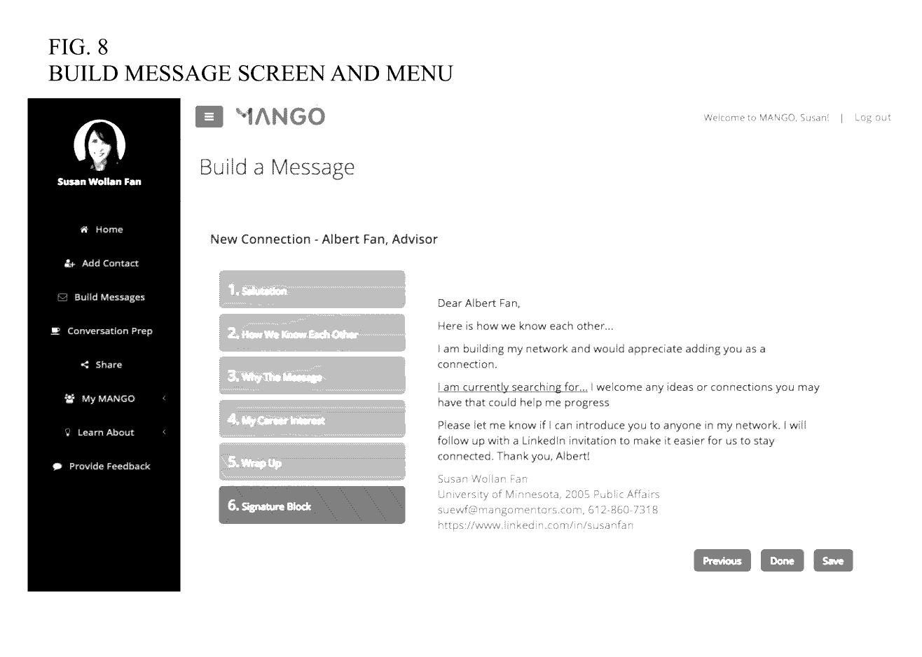

FIG. 6 illustrates a build messages process according to one embodiment of the disclosed system. FIG. 7 illustrates a message sample according to one embodiment of the disclosed system. FIG. 8 illustrates the Build Message screen and navigation menu.

Within the disclosed system, the user can initiate communications with a contact by building, customizing, editing, and sending common types of networking messages to a contact. The common types of networking communications related to but not limited to making a new connection, connecting others, and staying in touch with connections. Message types are written in a standard professional format and may include but are not limited to messages used to add a new connection, request a conversation, check in, confirm a meeting, thank a connection, ask to introduce someone, introduce others, refer someone, share an outcome, share a career change, and invite more help from the user's connections.

In some embodiments, the system can help the user to complete each sentence of a message by pulling in relevant user and contact data, providing default text or suggesting text customized to a contact's Connection Type, and by providing the user coaching, prompts and illustrative examples. In some embodiments, the system can save user-modified data so that the system can prepopulate in future messages. For example, in some embodiments saved user data can include a user's career interest statement, an “about me” sentence, and a signature block with the user's contact information. Messages can be sent by exporting to email, or alternatively other communication channels such as Linkedln Inmail, Facebook Messenger, Google Chat, or text messaging.

Conversation Preparation

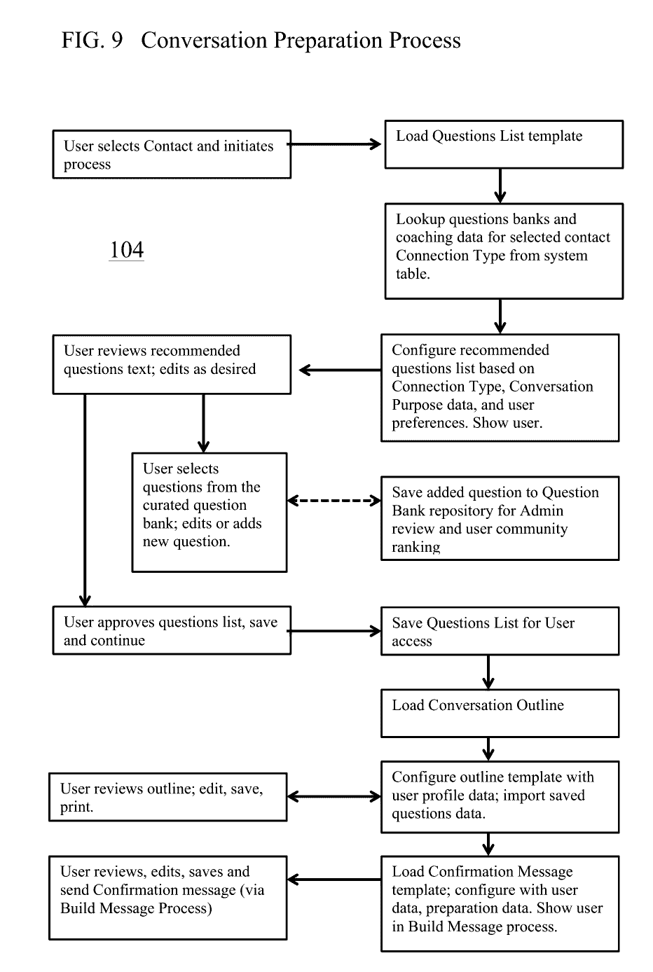

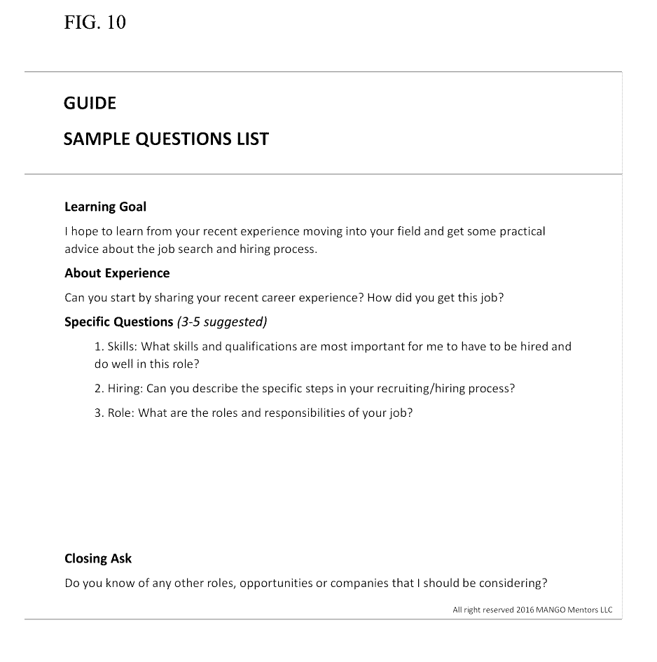

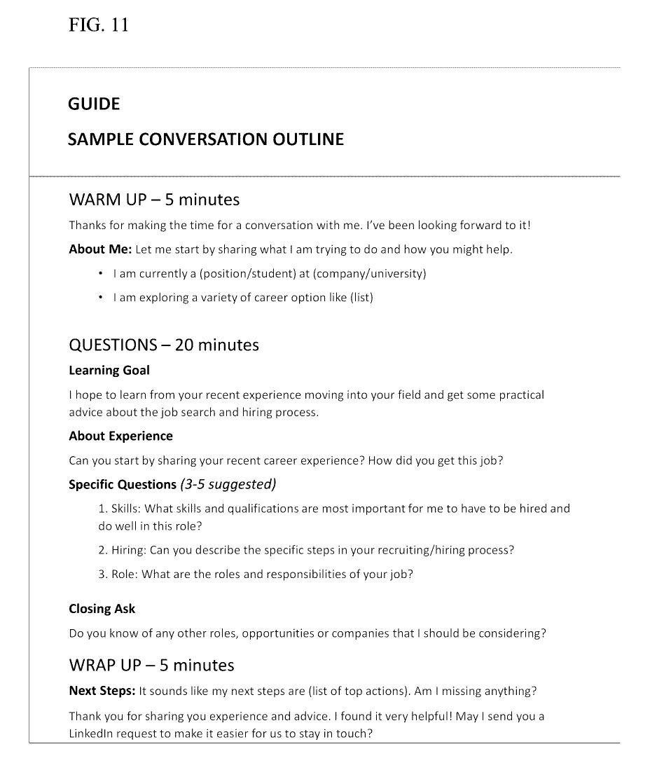

FIG. 9 illustrates how a user can prepare for a conversation by selecting questions, getting an outline, and sending a confirmation message, according to one embodiment of the disclosed system. FIG. 10 illustrates a sample questions list according to one embodiment of the disclosed system. FIG. 11 illustrates a sample conversation outline according to one embodiment of the disclosed system.

Within the disclosed system, the user can prepare for a conversation with a contact by viewing and editing questions that the system recommends for the specific contact based on the contact's Connection Type. The user is also able to select questions from a bank of curated, ranked questions submitted by users and others like recruiters and career counselors. The user is able to submit a question to the system to be considered for the question bank and made available to other users. The user can print the question list and import the questions into a full conversation outline that can be printed and used to guide a conversation with the contact. The user is also able to view, edit, save, and send a confirmation message that the system has auto-drafted from saved data (for example, contact information, meeting logistics, and questions).

Manage Connections

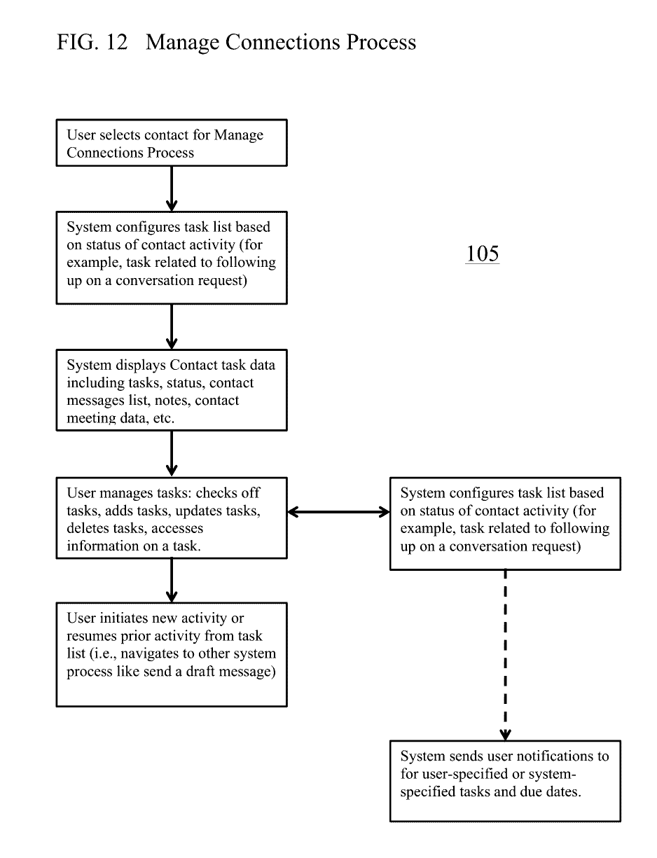

FIG. 12 illustrates the manage connections process. For a selected contact, the system can create a list of recommended tasks that a user can use to manage follow up activities for the contact. The system can recommend tasks related to a contact's networking use case. One example, if a user requests a conversation with a contact (i.e., informational interview), the system can provide a task list that can include, for example, schedule meeting, send confirmation, prepare questions, and send thank you message. Like a check-list, the user can check-off, edit, add, and delete tasks from the list.

A user can get coaching on a task to see how to complete the task and why the task is recommended. A user can set notifications to receive system-generated reminders to follow up on tasks within a specified timetable. The user can also review, resume, and complete prior tasks. One example, a user can view a list of the user's saved messages, question lists, and conversation outlines. The user can select a saved document and take a number of actions, for example, view a saved message, edit a draft message, send a message, or print a message. A user can be alerted if the user attempts to take an erroneous action with a contact (for example, rebuilding or resending a message that has already been sent to a contact).

Share

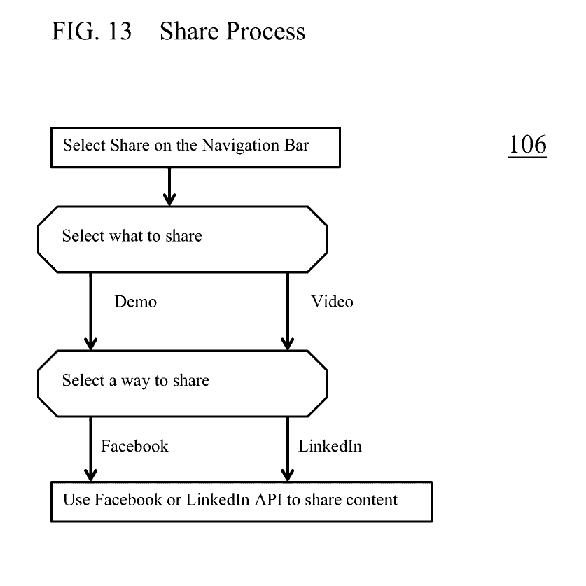

FIG. 13 illustrates how a user can share the product video and demo. Within the disclosed system, a user can share a product video and demo via email or social media. A user can also recommend a connection to a friend, as described above. Within the system, a user can share a short-text message with the full user community or with specified network community, or specific individuals, via a newsfeed.

In some embodiments, users can identify each other as friends and communicate via a chat function, leave semi-private comments on each other's profile page, share saved files, and recommend or share contacts, all from within the system.

In some embodiments, a user can select a one-click icon for communicating appreciation to a contact. The number of times a contact is thanked can be tracked and used in calculating a contact's responsiveness score. If the contact is thanked by a user, the system can also trigger an entry in the community newsfeed or the user's social networking sites.

Sign Up and Sign In

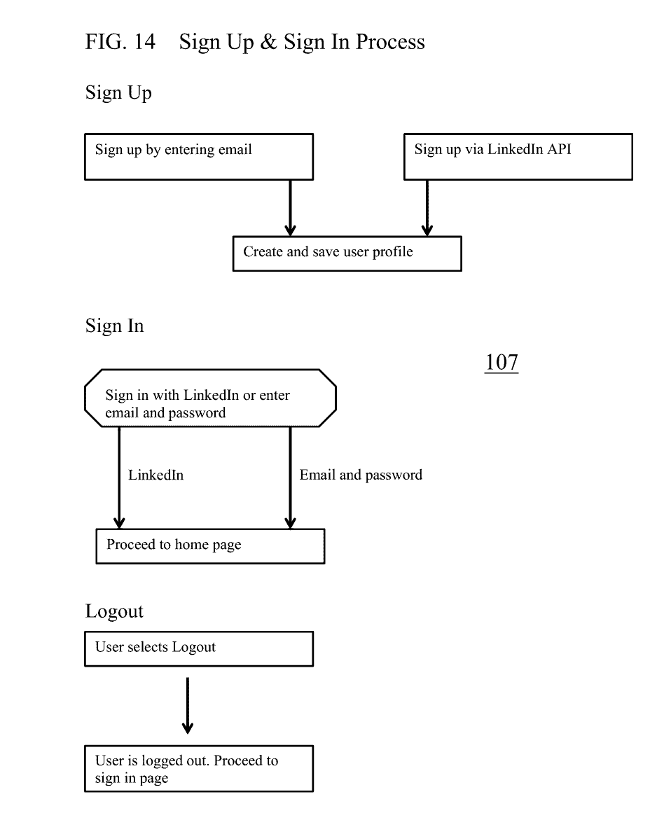

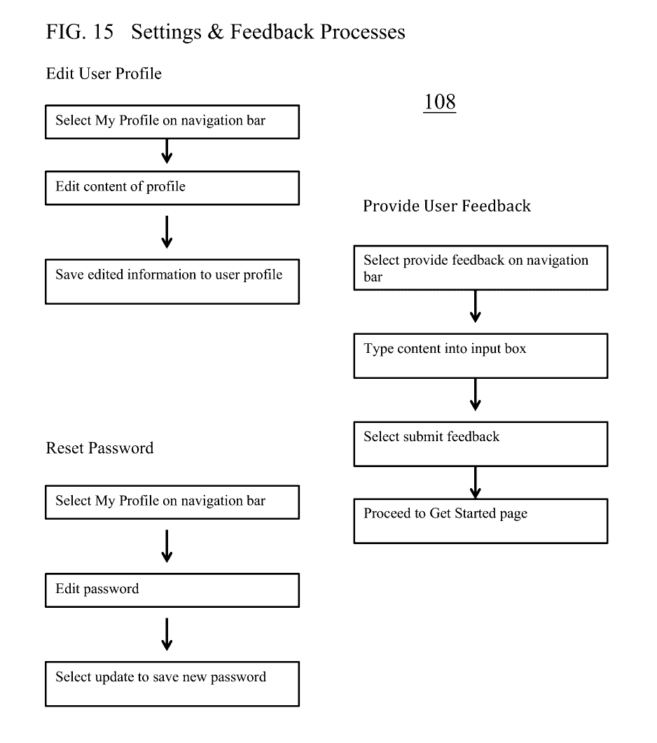

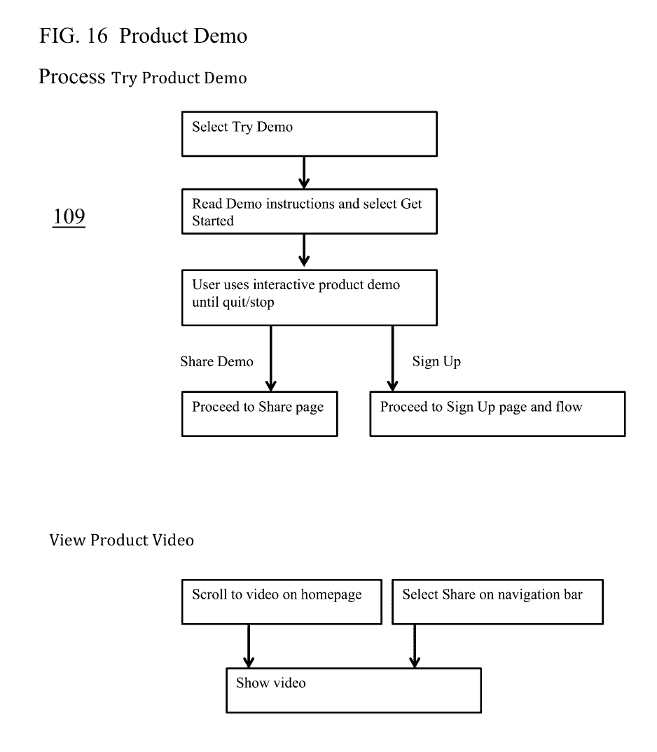

FIG. 14 shows sign up and sign in process. Within the system, a user can sign up, the process of which includes an account creation, email verification, a profile setup, an onboarding message, and navigating to a home screen to add a first contact. After an account is created, the user can sign in and be navigated to a home screen. In some embodiments, the sign in will be completed using the user's Linkedln credentials. From the navigation menu, the user has several options. The user can initiate several common functions like Add Contact 101, illustrated in FIG. 3, Build Messages 103, illustrated in FIGS. 6-8, Conversation Preparation 104, illustrated in FIG. 9-11, Manage Connections 105, illustrated in FIG. 12, and Share 106, illustrated in FIG. 13. From the My MANGO submenu, the user can view contacts, view messages and saved documents, and view the user's profile. From the Learn About submenu, the user can access resources within the product, for example, coaching tips, Connection Type descriptions, FAQs, and Try Demo, illustrated in FIG. 16. The user can provide also feedback, as illustrated in FIG. 15.

Settings and Feedback

FIG. 15 illustrates how a user can update their settings and give feedback. Within the disclosed system, a user can update the user profile data, update settings, reset the user's password, and give feedback on the product.

Demo

FIG. 16 illustrates how a user can try the demo and video. For example, the demo can allow the user to try using the proprietary functions of the system such as the Build a Message 103 function before or after signing up. At any time, the user can stop the demo and sign up, share the demo to social media, or email it to a friend. A user can choose to view a video demonstration of the product. The user can share the demo to social media or email it to a friend either before or after viewing the demo.

The following user story helps illustrate how the disclosed system benefits its users.

User Networking Story

User Problem: With the dawn of online applications, thousands of people may apply for every posted job and internship. A referral or insider advice helps an applicant to stand out and increases her/his chance of landing a desired position, but few seek help from their network.

Our research identifies several reasons those new to networking, like students and recent graduates, find reaching out to new connections difficult. One reason is that novices simple do not know how to network. They do not know the professional norms and expected practices so they are reluctant to try networking. Another reason is intimidation; they hate to cold-call professional contacts, and are often intimidated by people who are more advanced in their careers or whose advice is not relevant to their entry-level needs. A third reason is that novices are overwhelmed by too many search results and are unsure of how to select the best connections from among the results. A fourth reason relates communication. When new networkers find contacts they would like to connect with most are paralyzed by the task of writing a professional message that has the right tone and an appropriate request. A fifth reason relates to relationship management. People lives are demanding and many struggle to follow up with connections on a timely basis. Novices are often unaware that contacts can feel slighted when they fail to reach back, thank them, or share the outcome of their advice or referral. These mistakes can be embarrassing to novices and make contacts less likely to respond to future requests.

User Solution: The disclosed product is designed to overcome these problems by showing anyone, especially new networkers, how to network easily and confidently. The product searches a user's network and recommends connections that users can relate to, often only a few steps ahead of them from a career perspective. The product helps users to draft personalized, professional messages, select relevant questions, and follow-up appropriately. The product provides step-by-step coaching so users can build their networking skills and reach out to people in their network for help in exploring and securing new job opportunities.

Network Community Manager

In addition to individual users, the disclosed system can be used by organizations such as universities, professional associations, and affinity groups, to increase networking among its network community members. The system can have up-to-date profile, context, and network connections data, and can use analytics to provide network managers with engagement metrics and insights.

To enable an organization to expand networking by its community members, the system can run a customized algorithm on behalf of the organization to find and recommend connections between group members, and post these recommendations within a user's account.

In order to allow a community manager to see and understand a network group, its membership, its engagement activities, and the resulting outcomes, the system provides value-added analytics and insights such as community demographics, engagement activity, and member outcomes.

To determine community demographics, the system can take into account the makeup of the network in terms of diversity of fields of study, industry, geography, professional tenure/experience, and network connections.

To determine engagement activity, the system can provide group activity insights, member insights, and segment insights. Group activity insights can include but are not limited to measuring connections, messages, responses, conversations, and referrals in the community. For example, insights can include the number of people, the specific people who are participating, how the activity is spread out among the network, the amount of trial members, the amount of trial members converted into full time members, the number of new members, the amount of repeat activity, etc. Member insights can provide data on the most influential members (i.e., the most connected members of a community; the strongest networks), the most valuable players (e.g., the members with the most introductions and referrals; most responsive members), and the most in-demand segments (i.e., which members are trending; the parts of the network that are most often showing up in searches and match activity). Segment insights can indicate the most and least active segments of the community so that the community manager know which segment may need extra effort to increase engagement activity.

Outcomes and results can include major outcomes, interim milestone reporting, and longitudinal outcomes. For a University organization, major outcomes may include student graduation rates, career outcomes, and social capital growth (like increases in students' number and field-specific connections). Interim milestone reporting may include progress of students in building professional profiles, projects, externship/internship experiences, work experiences, skills development, etc. Longitudinal outcomes may include career outcomes by graduating classes, degrees, or sub-segments.

System Hardware

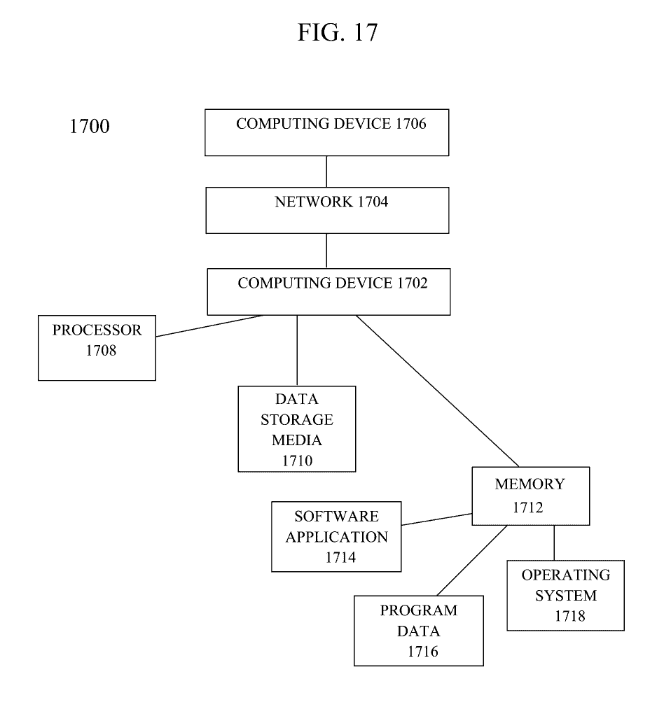

In some embodiments, the system described herein uses a computing system to carry out the various functions described herein. FIG. 17 is a schematic block diagram of an example computing system 1700. The example computing system 1700 includes at least one computing device 1702. In some embodiments the computing system 1700 further includes a communication network 1704 and one or more additional computing devices 1706 (such as a server).

The computing device 1702 can be located in a user's home or other place of business. In some embodiments, computing device 1702 is a mobile device. The computing device 1702 can be a stand-alone computing device or a networked computing device that communicates with one or more other computing devices 1706 across a network 1704. The additional computing device(s) 1706 can be, for example, located remotely from the first computing device 1702, but configured for data communication with the first computing device 1702 across a network 1704.

In some examples, the computing devices 1702 and 1706 include at least one processor or processing unit 1708 and system memory 1712. The processor 1708 is a device configured to process a set of instructions. In some embodiments, system memory 1712 may be a component of processor 1708; in other embodiments system memory 1712 is separate from the processor 1708. Depending on the exact configuration and type of computing device, the system memory 1712 may be volatile (such as RAM), non-volatile (such as ROM, flash memory, etc.) or some combination of the two. System memory 1712 typically includes an operating system 1718 suitable for controlling the operation of the computing device 1702, such as the WINDOWS® operating systems or the OS X operating system, or a server, such as Windows SharePoint Server, also from Microsoft Corporation, or such as a Mac Mini with OS X. The system memory 1712 may also include one or more software applications 1714 and may include program data 1716.

The computing device 1702 may have additional features or functionality. For example, the computing device 1702 may also include additional data storage devices 1710 (removable and/or non-removable) such as, for example, magnetic disks, optical disks, or tape. Computer storage media 1710 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 1710 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing device 1702. An example of computer storage media 1710 is non-transitory media.

In some examples, one or more of the computing devices 1702 and 1706 can be located in an establishment. In other examples, the computing device 1702 can be a personal computing device that is networked to allow the user to access and utilize the system disclosed herein from a remote location, such as in a user's home, office or other location. In some embodiments, the computing device 1702 is a smart phone tablet, laptop computer, personal digital assistant, or other mobile device. In some embodiments, system operations and functions are stored as data instructions for a smart phone application. A network 1704 facilitates communication between the computing device 1702 and one or more servers, such as an additional computing device 1706, that hosts the system. The network 1704 may be a wide variety of different types of electronic communication networks. For example, the network 1704 may be a wide-area network, such as the Internet, a local-area network, a metropolitan-area network, or another type of electronic communication network. The network 1704 may include wired and/or wireless data links. A variety of communications protocols may be used in the network 1704 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1706 is a Web server. In this example, the first computing device 1702 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 1708 of the one or more computing devices 1702 or 1706, the instructions cause the processor 1708 to perform one or more of the operations or methods disclosed herein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method for facilitating and building professional interactions, the method comprising:
adding a contact;
identifying the connection type of a contact;
specifying search criteria for connection recommendations;
conducting search within social network database;
reviewing recommended connection results;
reviewing details about a recommended connection;
selecting a recommended connection to add as a contact;
initiating a message to a selected contact;
selecting a message builder template;
customizing suggested text within a message;
getting coaching, prompts and examples to help customize message text;
error-proofing, editing, saving a draft message;
sending a message from an external email or webmail client;
creating a questions list for a contact;
reviewing recommended questions for a contact;
editing questions for a contact;
selecting questions from among a curated question bank;
submitting questions for use by other users and question bank;
drafting a conversation outline;
creating a task list for following up with a contact;
managing follow up tasks for a contact;
setting notification for tasks;
viewing and editing previously drafted and previously sent messages;
managing contacts;
managing saved files (e.g., drafts, messages, questions list, outlines);
getting personalized coaching tips;
recommending a connection to others;
sharing a short-text message via a newsfeed;
identifying other users as friends to allow common social features; and
sharing product, video and demo via email and social media.

2. A method for organizations to manage the networking engagement of their community members, the method comprising:
recommending connections to and among members of the organization's network community;
reviewing analytics and insights related to the organization's network community and its members; and
initiating and curating short-text communications to the organization's network community.
